(19) United States
(12) Patent Application Publication
(10) Pub. No.: US 2008/0178228 A1
(43) Pub. Date: Jul. 24, 2008

(54) COMMUNICATION SYSTEM FOR HOME NETWORKING

(75) Inventors: Keun-joo PARK, Yongin-si (KR); Hyun-chin Kim, Seongnam-si (KR); Young-kwang Seo, Seoul (KR); Yeong-bae Yeo, Daegu (KR)

Correspondence Address: STEIN, MCEWEN & BUI, LLP, 1400 EYE STREET, NW, SUITE 300, WASHINGTON, DC, 20005, US

(73) Assignee: Samsung Electronics, Co.,, Suwon-si (KR)

(21) Appl. No.: 11/870,555

(22) Filed: Oct. 11, 2007

(30) Foreign Application Priority Data
Jan. 24, 2007 (KR) 2007-7565

(51) Int. Cl. H04N 7/18; H04N 7/16

(52) U.S. Cl. 725/78; 725/143

(57) ABSTRACT

A communication system for home networking, the home networking communication system including: a plurality of repeaters that are respectively provided in some zones from among a plurality of zones, a splitter that is connected to the plurality of repeaters through a coaxial cable, and a hub that is provided in one zone from among the plurality of zones, is connected to the splitter through the coaxial cable, and relays data communication between the plurality of repeaters. Accordingly, a cost for installation is reproduced and an installation of the communication system is more convenient.

### CROSS-REFERENCE TO RELATED APPLICATION

This application claims all benefits accruing under 35 U.S.C. §119 from Korean Patent Application No. 2007-7565, filed on Jan. 24, 2007 in the Korean Intellectual Property Office, the disclosure of which is incorporated herein by reference.

### BACKGROUND OF THE INVENTION

1. Field of the Invention

Aspects of the present invention relate to a communication system for home networking, and more particularly, to a home networking communication system that reduces a cost of installing home networks and contributes to the convenience of the public.

2. Description of the Related Art

A home network is a communication network for transmitting and/or receiving a plurality of audio/video signals, multimedia signals, and Internet signals in real-time at home by connecting rooms of the home through a communication line.

The communication line should be installed in order to build the home network. For example, the home network is built by installing unshielded twisted pair (UTP), shielded twisted pair (STP), plastic optical fiber (POF), and/or glass optical fiber (GOF), which are wired communication lines currently used in home networks. However, the home networks built in this way incur a high cost of installation. Accordingly, a home networking technology using a power line has been recently developed.

FIG. 1 is a block diagram illustrating a conventional home networking communication system 100. Referring to FIG. 1, in a home networking communication system 100 using a coaxial cable for receiving a television (TV) signal, the TV signal amplified by a splitter 17 goes through a combiner 15 installed in concatenations Q1, Q2, Q3 and Q4 on each distribution line and is distributed to connectors a, b, c and d, which are installed in each room, through a coaxial cable 19 installed on a level lower than the level of the combiner 15. That is, the home network of a star format is built on the basis of an Institute of Electrical and Electronics Engineers (IEEE) 1394 module 11 of a hub 10. Also, each of the connectors a, b, c, and d is arranged in each terminal of the network.

The IEEE 1394 module 11 and a repeater 13 are connected through an IEEE 1394 cable 12. The repeater 13 and the combiner 15 are connected through the coaxial cable 19. The repeater 13 is used as a multimedia converter in each room.

The hub 10 of the conventional home networking communication system is installed in a switchboard of the home. When the hub 10 is added, the hub 10 should be installed after the TV signal and an IEEE 1394 communication line are divided. Therefore, installing the conventional home networking communication system is difficult and costly.

### SUMMARY OF THE INVENTION

Aspects of the present invention provide a home networking communication system that can reduce a cost of installing home networks and contribute to the convenience of the public.

According to an aspect of the present invention, there is provided a home networking communication system including: a plurality of repeaters respectively provided in one or more zones from among a plurality of zones, a hub provided in one zone from among the plurality of zones to relay data between the plurality of repeaters, and a splitter that is connected to a plurality of repeaters and the hub through a coaxial cable.

The hub may include two repeaters which are connected to perform data communication between terminals, and a 1394a module that connects the two repeaters.

Each of the repeaters may include an interactive communication module that converts a frequency band of the data, and a 1394b module that transmits and receives the data whose frequency band is converted to and from the terminal.

The interactive communication module may adopt an ultra wide band (UWB) transmitting method.

Each of the repeaters may transmit and receives data based on a high frequency band.

According to another aspect of the present invention, there is provided a hub arranged in one zone among from a plurality of zones, the hub including: a combiner that is connected to a splitter through a coaxial cable installed in one zone, two repeaters that are connected to each other to relay data between a plurality of repeaters that are provided in the other zones of the plurality of zones and connected to the splitter through the coaxial cable, and a 1394a module that connects the two repeaters.

Each of the repeaters may include an interactive communication module that converts a frequency band of the data, and a 1394b module that transmits and receives the data whose frequency band is converted to and from the terminal.

According to another aspect of the present invention, there is provided a communication system for a network divided into a plurality of zones, the communication system including: a first repeater provided in a first zone; a second repeater provided in a second zone; a hub provided in a third zone to relay data between the first repeater and the second repeater; and a splitter that is connected to the first repeater, the second repeater, and the hub through a communication line.

According to yet another aspect of the present invention, there is provided a method of transmitting data in a network divided into a plurality of zones, the method including: connecting a first repeater in a first zone, a second repeater in a second zone, and a hub in a third zone to a splitter through a communication line; and transmitting data between the first repeater and the second repeater through the hub.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram illustrating a conventional home networking communication system;

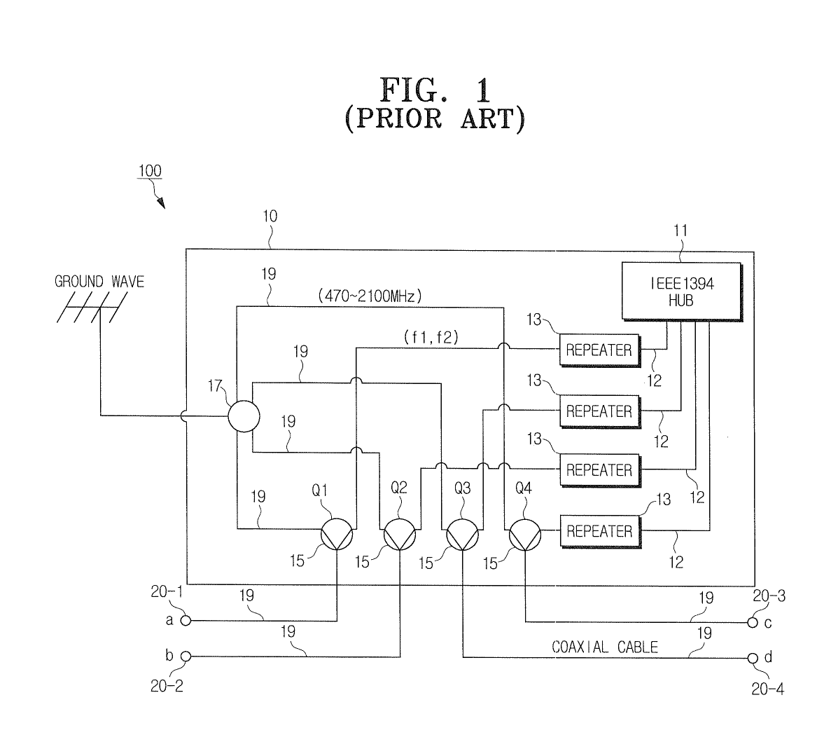

FIG. 2 is a block diagram illustrating a home networking communication system according to an embodiment of the present invention;

FIG. 3 is a block diagram illustrating the home networking communication system of FIG. 2; and

FIG. 4 illustrates a data communication use frequency band in the home networking communication system according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

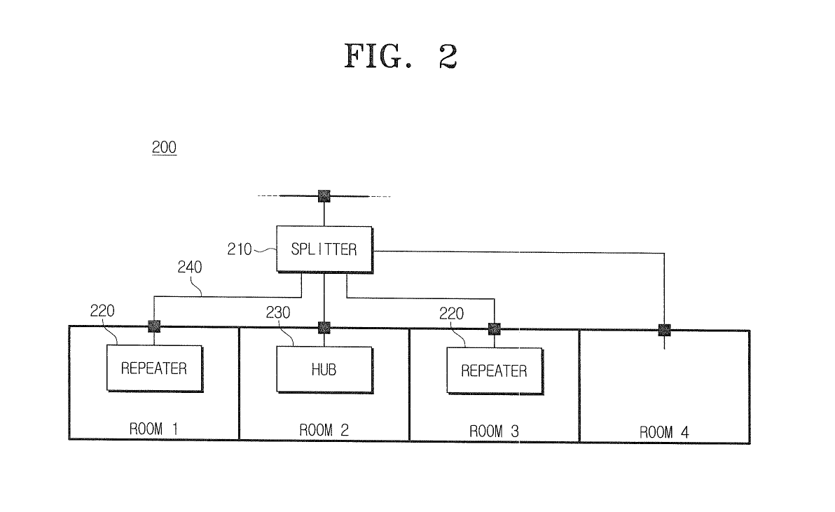

FIG. 2 is a block diagram illustrating a home networking communication system 200 according to an embodiment of the present invention. A home network controls terminals through a wired/wireless network (such as the Internet) and enables the terminals to share data. The terminals may be home appliances, such as a refrigerator, an air conditioner, a microwave oven, and a television (TV). However, it is understood that aspects of the present invention are not limited to home networks, and may be implemented in other network systems (such as an office network).

Referring to FIG. 2, the home networking communication system 200 includes a splitter 210, repeaters 220, and a hub 230. The splitter 210 distributes a coaxial cable 240 (or another type of communication line) to each zone in a home. The repeaters 220 are arranged in a plurality of the zones. Each of the repeaters 220 is connected to the splitter 210 through a distributed coaxial cable 240 (or another type of communication line). The hub 230 relays communications between the repeaters 220

The splitter 210 distributes the coaxial cable 240 (or another type of communication line). That is, the splitter 210 can distribute one communication line throughout a plurality of zones.

The repeaters 220 connect a plurality of terminals performing local data communication in order for the terminals to communicate with each other. That is, the repeaters 220, which are individually arranged in some zones from among a plurality of zones in the home, amplify and transmit and/or receive data between terminals. Also, each repeater 220 is used to extend a transmission and/or reception distance in transmitting and/or receiving data or to increase the number of ports required for transmission and/or reception. The repeater 220 can transmit data (such as an audio/video signal) at high-speed and in real-time based on, for example, the Institute of Electrical and Electronics Engineers (IEEE) 1394 communication. Using this protocol, a maximum transmission speed may be 400 megabytes per second (Mbps) and a maximum transmission distance may be 100 meters.

Furthermore, the repeater 220 may be operated in a physical layer of an open systems interconnection (OSI) reference model to amplify data. However, the repeater 220 does not affect the traffic of the network. That is, the repeater 220 can perform frequency up-conversion on data by a radio frequency (RF) signal to avoid interference with a television broadcasting signal. Accordingly, the repeater 220 can transmit and/or receive data based on a high frequency band.

The hub 230 connected to the splitter 210 through the coaxial cable 240 (or other communication line) can relay communication between a plurality of the repeaters 220. The hub 230 may, although not necessarily, be arranged in a zone between the zones in which the repeaters 220 are arranged. For example, as illustrated in FIG. 2, the hub 230 transmits data received through the repeater 220 of room 1 to the repeater 220 of room 3 in order to transmit data of a terminal of the room 1 to a terminal of the room 3. Subsequently, the repeater 220 of the room 3 outputs the data to the terminal accessed by the repeater 220 of the room 3. Accordingly, the terminals of the room 1 and room 3 can communicate with each other.

In the home networking communication system 200 illustrated in FIG. 2, a first repeater 220, the hub 230, and a second repeater 220 are arranged in the rooms 1, 2 and 3, respectively. The terminal accessed by the repeater 220 of the room 1 and the terminal accessed by the repeater 220 of the room 3 are connected to each other through the hub 230 of the room 2. Therefore, the terminal of room 1 and the terminal of room 3 can transmit and/or receive data to/from each other. Moreover, the hub 230 and the repeaters 220 of each room (or zone) can transmit and/or receive data by connecting to the splitter 210 through the coaxial cable 240.

The coaxial cable 240 is distributed to each room. However, it is understood that another type of communication line other than a coaxial cable 240 may be used to connect the terminals to the splitter 210. Accordingly, when a first terminal intends to communicate with a second terminal of a room (or zone) where the repeater 220 and the hub 230 are not provided, the first and second terminals can transmit and/or receive data with each other by additionally connecting the hub 230 to the second terminal. That is, referring to FIG. 2, when the hub 230 is additionally connected, via the coaxial cable 240, to a terminal of room 4, the terminal of the room 4 connected to the hub 230 can communicate with the terminals of the rooms 1, 2 and 3 at a high speed.

Since the home network system 200 enables data communication between terminals of each room (or zone) by connecting the hub 230 and one or more repeaters 220 to the terminals via the coaxial cable 240 (or other type of communication line) distributed to each room (or zone), it is possible to reduce a cost of installation and contribute to the convenience of the user.

Although it is described in the embodiment that data is transmitted based on the IEEE 1394 communication in the hub 230 and the repeaters 220, the hub 230 and the repeaters 220 may be realized based on other communication standards, such as Ethernet communication and universal serial bus (USB) communication. Therefore, the description of the current embodiment does not limit the communication method of the hub 230 and the repeaters 220 arranged in each zone.

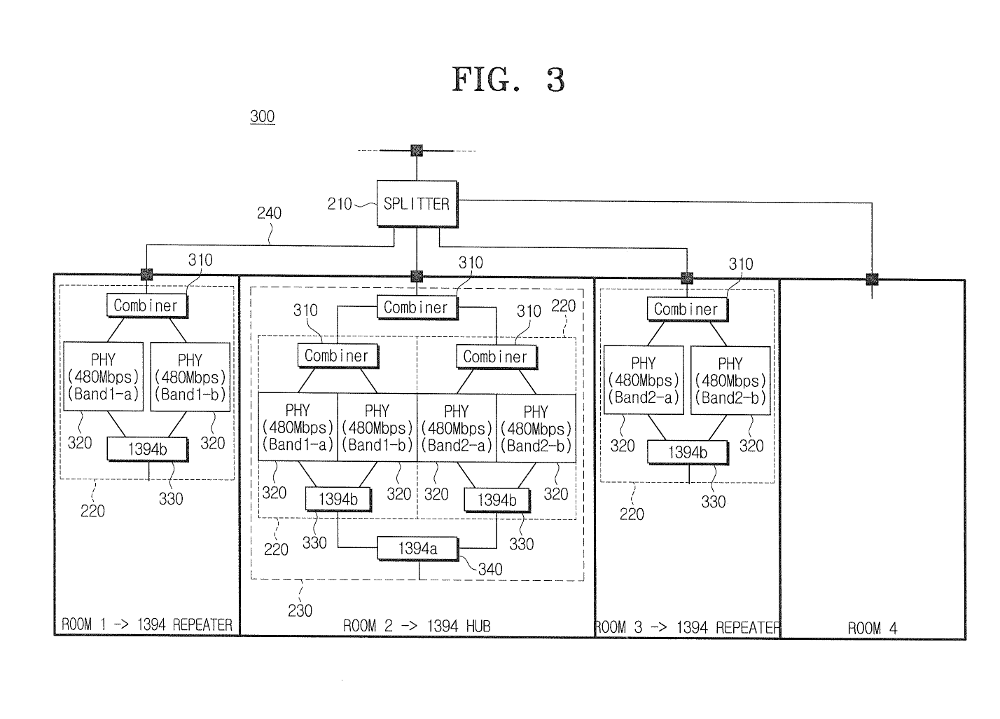

FIG. 3 is a block diagram illustrating a home networking communication system 300 of FIG. 2. Referring to FIG. 3, since the constituent elements having the same reference number as the constituent elements of FIG. 2 perform the same functions as the constituent elements of FIG. 2, the constituent elements will not be described herein.

Each of the repeaters 220 arranged in the rooms 1 and 3 include a combiner 310, one or more interactive communication modules 320, and a 1394b module 330.

The combiner 310 can divide and/or combine data transmitted through the coaxial cable 240 connected to the splitter 210. The combiner 310 outputs the divided data to the interactive communication module 320. Also, the combiner 310 combines data that is frequency-converted by the interactive communication module 320 and outputs the frequency-converted data to the coaxial cable 240.

The interactive communication module 320 converts data of a low frequency band supported in the 1394b module 330 into data of a high frequency band. Also, the interactive communication module 320 converts data of a high frequency band into data of a low frequency band. That is, in the interactive communication module 320, data supported in the 1394b module 330 having a transmission speed of 480 Mbps is distributed at a low frequency band where an output frequency spectrum ranges between 0 Hz and 480 MHz. The interactive communication module 320 performs frequency up-conversion on the data of the low frequency band into data of a band higher than 900 MHz, which is a frequency band of the RF signal. Reversely, when the data of the high frequency band is provided through the combiner 310, the interactive communication module 320 performs frequency down-conversion on the data of the high frequency band into the data of the low frequency band.

A communicating method by frequency up-conversion may be an interactive communication module using amplitude shift keying (ASK), phase shift keying (PSK), quadrature phase shift keying (QPSK), quadrature amplitude modulation (QAM), and ultra wide band (UWB). An occupied bandwidth may be changed according to the modulating method. It is possible to avoid interference of the frequency band of the cable television signal by transmitting and/or receiving data based on the high frequency band.

The 1394b module 330 can transmit the frequency-converted data to the terminal through the interactive communication module 320. That is, the 1394b module 330 transmits and/or receives data between the terminals accessed by the repeater 220 based on a protocol used to extend a data transmission distance. For example, the 1394b module supports a transmission distance longer than 100 meters.

The hub 230 provided in the room 2 includes the combiner 310, two repeaters 220 and a 1394a module 340. The combiner 310 can divide and/or combine data transmitted through the coaxial cable 240 connected to the splitter 210. The two repeaters 220 can transmit and/or receive data of the terminal accessed by the repeaters 220 of the rooms 1 and 3. The 1394a module 340 can connect the two repeaters 220 included in the hub. That is, the 1394a module 340 can share data communication between the repeaters 220 of the rooms 1 and 3 by connecting the two repeaters 220 included in the hub 230 through a cable.

A use frequency band in performing data communication will be described hereinafter as an example. When data of the terminal accessed by the repeater 220 of the room 1 is transmitted to the terminal accessed by the hub 230 of the room 2, the data transmission frequency band of the room 1 is band 1-a and the data reception frequency band of the room 2 is a band 1-a. Reversely, the data transmission frequency band of the room 2 is a band 1-b and the data reception frequency band of the room 1 is the band 1-b.

When data of the terminal accessed by the hub 230 of the room 2 is transmitted to the terminal accessed to the repeater 220 of the room 3, the data transmission frequency band of the room 2 is a band 2-a and the data reception frequency band of the room 3 is the band 2-a. Reversely, the data transmission frequency band of the room 3 is a band 2-b and the data reception frequency band of the room 2 is the band 2-b.

Meanwhile, when the data of the terminal accessed by the repeater 220 of the room 1 is transmitted to the terminal accessed by the repeater 220 of the room 3, the data transmission frequency band of the room 1 is not a band 3-a and the data transmission frequency band of the room 3 is not a band 3-b. Rather, because two repeaters 220 are connected through a cable inside the hub 230, it is possible to share the data. Accordingly, the data transmission frequency band of the room 1 is the band 1-a and the data reception frequency band of the room 3 is the band 2-a. Reversely, the data transmission frequency band of the room 3 is the band 2-b and the data reception frequency band of the room 1 is the band 1-b.

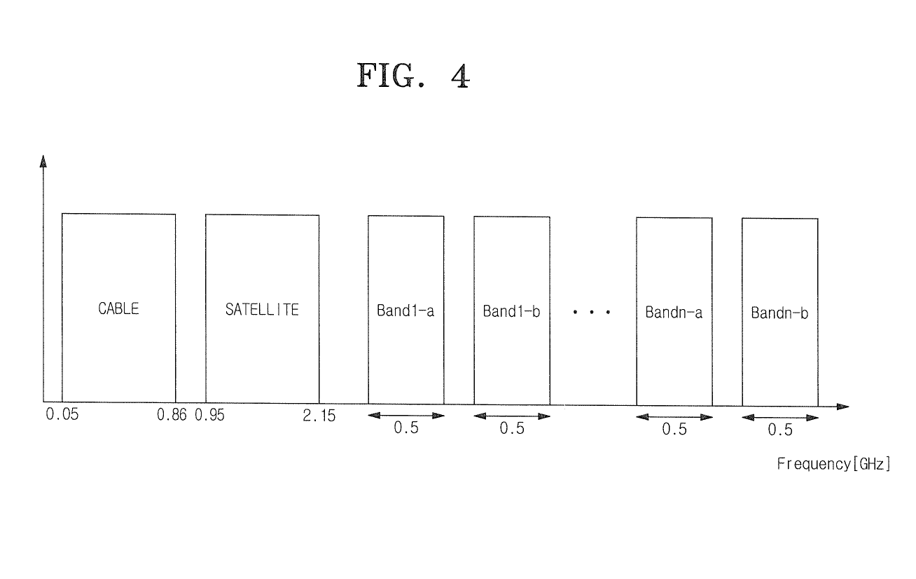

FIG. 4 shows a data communication use frequency band in the home networking communication system according to an embodiment of the present invention. Referring to FIG. 4, in the home networking communication system divided into a plurality of zones, a cable television signal generally adopts a frequency band ranging from 0.05 GHz to 0.86 GHz and a satellite signal adopts a frequency band ranging from 0.95 GHz to 2.15 GHz. The cable television signal and the satellite signal are transmitted to a terminal of each zone.

In each zone (where each zone may, although not necessarily, represent a room) a frequency band used when communication between terminals is performed is higher than 2.15 GHz in order to avoid interference of the cable television signal and the satellite signal. As illustrated in FIG. 4, each of the frequency bands used for communication between the terminals may have a range of 0.5 GHz. Accordingly, data communication between the terminals of each zone can be smoothly performed.

As described above, according to aspects of the present invention, it is possible to reduce cost for home networking and contribute to the convenience of the public by connecting hub and repeater to a coaxial cable distributed in a plurality of zones. It is also possible to transmit data at a high speed and contribute to the convenience of the user by performing data communication based on the hub and the repeater.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A communication system for a network divided into a plurality of zones, the communication system comprising:
a plurality of repeaters respectively provided in one or more first zones from among the plurality of zones;
a hub provided in a second zone from among the plurality of zones to relay data between the plurality of repeaters; and
a splitter that is connected to the plurality of repeaters and the hub through a coaxial cable.

2. The communication system as claimed in claim 1, wherein the hub comprises:
two repeaters that are connected to each other to relay the data between the plurality of repeaters.

3. The communication system as claimed in claim 2, wherein the hub further comprises:
a 1394a module that connects the two repeaters.

4. The communication system as claimed in claim 1, wherein each of the plurality of repeaters comprises:
an interactive communication module to convert a frequency band of the data; and
a 1394b module to transmit and to receive the data whose frequency band is converted to and from a terminal.

5. The communication system as claimed in claim 4, wherein the terminal is a home appliance.

6. The communication system as claimed in claim 2, wherein each of the plurality of repeaters comprises:
an interactive communication module to convert a frequency band of the data; and
a 1394b module to transmit and to receive the data whose frequency band is converted to and from a terminal.

7. The communication system as claimed in claim 6, wherein the terminal is a home appliance.

8. The communication system as claimed in claim 4, wherein the interactive communication module adopts an ultra wide band (UWB) transmitting method.

9. The communication system as claimed in claim 6, wherein the interactive communication module adopts an ultra wide band (UWB) transmitting method.

10. The communication system as claimed in claim 1 wherein the plurality of repeaters transmit and receive data based on a high frequency band.

11. The communication system as claimed in claim 1, wherein:
the splitter is connected to a terminal of a third zone, not having one of the plurality of repeaters or the hub, through the coaxial cable; and
the hub relays the data between the terminal of the third zone and the plurality of the repeaters.

12. The communication system as claimed in claim 3, wherein the hub further comprises:
a combiner that is connected to the splitter through the coaxial cable and combines and/or divides the data.

13. The communication system as claimed in claim 4, wherein each of the plurality of receivers further comprises:
a combiner that is connected to the splitter through the coaxial cable and combines and/or divides the data.

14. The communication system as claimed in claim 1, wherein the communication system is a home networking communication system.

15. A hub arranged in one zone from among a plurality of zones of a network having a splitter and a coaxial cable, the hub comprising:
a combiner that is connected to the splitter through the coaxial cable installed in the one zone;
two repeaters that are connected to each other to relay data between a plurality of repeaters that are provided in other zones of the plurality of zones and connected to the splitter through the coaxial cable; and
a 1394a module that connects the two repeaters.

16. The hub as claimed in claim 15, wherein each of the plurality of repeaters comprises:
an interactive communication module to convert a frequency band of the data; and
a 1394b module to transmit and to receive the data whose frequency band is converted to and from a terminal.

17. A communication system for a network divided into a plurality of zones, the communication system comprising:
a first repeater provided in a first zone;
a second repeater provided in a second zone;
a hub provided in a third zone to relay data between the first repeater and the second repeater; and
a splitter that is connected to the first repeater, the second repeater, and the hub through a communication line.

18. The communication system as claimed in claim 17, wherein the third zone is located between the first zone and the second zone.

19. The communication system as claimed in claim 17, wherein the communication line is a coaxial cable.

20. The communication system as claimed in claim 17, wherein the hub comprises:
a third repeater to transmit and/or receive the data to/from the first repeater; and
a fourth repeater to transmit and/or receive the data to/from the second repeater and to connect to the third repeater in order to relay the data between the first repeater and the second repeater.

21. The communication system as claimed in claim 20, wherein the hub further comprises:
a 1394a module that connects the third repeater and the fourth repeater.

22. The communication system as claimed in claim 17, wherein:
the first repeater comprises:
a first interactive communication module to convert a frequency band of the data, and
a first 1394b module to transmit and to receive the data whose frequency band is converted to and from a first terminal in the first zone; and
the second repeater comprises:
a second interactive communication module to convert a frequency band of the data, and
a second 1394b module to transmit and to receive the data whose frequency band is converted to and from a second terminal in the second zone.

23. The communication system as claimed in claim 20, wherein:
the first repeater comprises:
a first interactive communication module to convert a frequency band of the data, and
a first 1394b module to transmit and/or to receive the data, whose frequency band is converted, to/from a first terminal in the first zone; and
the second repeater comprises:
a second interactive communication module to convert the frequency band of the data, and
a second 1394b module to transmit and/or to receive the data, whose frequency band is converted, to/from a second terminal in the second zone.

24. The communication system as claimed in claim 23, wherein:
the first interactive communication module converts the frequency band of the data to a first band when the data is transmitted from the first terminal to a third terminal in the third zone;
the second interactive communication module converts the frequency band of the data to a second band when the data is transmitted from the second terminal to the third terminal;
the third repeater converts the frequency band of the data to a third band when the data is transmitted from the third terminal to the first terminal;
the fourth repeater converts the frequency band of the data to a fourth band when the data is transmitted from the third terminal to the second terminal;
the first interactive communication module converts the frequency band of the data to the first band and then the fourth repeater converts the frequency band of the data to the fourth band when the data is transmitted from the first terminal to the second terminal; and
the second interactive communication module converts the frequency hand of the data to the second band and the third repeater converts the frequency band of the data to the third band when the data is transmitted from the second terminal to the first terminal.

25. The communication system as claimed in claim 22, wherein:
the first interactive communication module converts the frequency band of the data to a first band when the data is transmitted from the first terminal to the second terminal; and
the second interactive communication module converts the frequency band of the data to a second band when the data is transmitted from the second terminal to the first terminal.

26. The communication system as claimed in claim 25, wherein:
the hub receives the data from the first repeater and converts the data from the first band to a third band when the data is transmitted from the first terminal to the second terminal; and
the hub receives the data from the second repeater and converts the data from the second band to a fourth band when the data is transmitted from the second terminal to the first terminal.

27. The communication system as claimed in claim 17, wherein the first repeater and the second repeater transmit and/or receive the data based on a high frequency band.

28. The communication system as claimed in claim 17, wherein:
the splitter is connected to a terminal of a fourth zone, not having a repeater or the hub, through the communication line; and
the hub relays the data between the terminal of the fourth zone and the first repeater and/or the second repeater.

29. The communication system as claimed in claim 17, wherein the communication line is not divided into a TV signal and a data line before the hub is provided in the third zone.

30. A method of transmitting data in a network divided into a plurality of zones, the method comprising:
connecting a first repeater in a first zone, a second repeater in a second zone, and a hub in a third zone to a splitter through a communication line; and
transmitting data between the first repeater and the second repeater through the hub.

31. The method as claimed in claim 30, wherein the third zone is located between the first zone and the second zone.

32. The method as claimed in claim 30, wherein the communication line is a coaxial cable.

33. The method as claimed in claim 30, wherein the transmitting of the data between the first repeater and the second repeater comprises:
converting a frequency band of the data to a first band when the data is transmitted from the first repeater to the second repeater; and
converting a frequency band of the data to a second band when the data is transmitted from the second repeater to the first repeater.

34. The method as claimed in claim 33, wherein transmitting of the data between the first repeater and the second repeater further comprises:
transmitting the data converted to the first band from the first repeater to the hub, converting the frequency band of the data at the hub from the first band to a third band, and transmitting the data in the third band to the second repeater when the data is transmitted from the first terminal to the second terminal; and
transmitting the data converted to the second band from the second repeater to the hub, converting the frequency band of the data at the hub from the second band to a fourth band, and transmitting the data in the fourth band to the first repeater when the data is transmitted from the second terminal to the first terminal.

35. The method as claimed in claim 34, further comprising:
transmitting and/or receiving the data to/from a terminal connected to the hub.

36. The method as claimed in claim 35, wherein the transmitting of the data to the terminal connected to the hub comprises:
converting the frequency band of the data to the first band when the data is transmitted from the first repeater to the terminal connected to the hub; and
converting the frequency band of the data to the second band when the data is transmitted from the second repeater to the terminal connected to the hub.

37. The method as claimed in claim 30, wherein the communication line is not divided into a TV signal and a data line before the hub is provided in the third zone.
